(19) United States
(12) Patent Application Publication
(10) Pub. No.: US 2024/0416700 A1
(43) Pub. Date: Dec. 19, 2024

(54) SUSPENSION ARM DEVICE AND MANUFACTURING METHOD THEREOF

(71) Applicant: ILJIN Co., Ltd., Gyeongju-si Gyeongsangbuk-do (KR)

(72) Inventors: Soon Chan KWON, Gimcheon-si Gyeongsangbuk-do (KR); Min Kook PARK, Gyeongju-si Gyeongsangbuk-do (KR)

(73) Assignee: ILJIN Co., Ltd., Gyeongju-si Gyeongsangbuk-do (KR)

(21) Appl. No.: 18/679,710

(22) Filed: May 31, 2024

(30) Foreign Application Priority Data
Jun. 15, 2023 (KR) 10-2023-0076689

(51) Int. Cl. B60G 7/00

(52) U.S. Cl. CPC B60G 7/001; B60G 7/005; B60G 2204/41; B60G 2204/416; B60G 2206/8201

(57) ABSTRACT

A suspension arm device includes a body portion, and a panel portion including a plurality of fixing portions fixed to the body portion. One surfaces of the fixing portions which face the body portion have a shape in which the one surfaces correspond to an outer surface of the body portion.

### CROSS-REFERENCE TO RELATED APPLICATION

This application claims priority to Korean Patent Application No. 10-2023-0076689 filed on Jun. 15, 2023, the entire contents of which are herein incorporated by reference.

### TECHNICAL FIELD

The present disclosure relates to a suspension arm device and a method of manufacturing the same.

### BACKGROUND

A suspension device of a vehicle is a device for connecting a wheel to a vehicle body, and includes a spring for absorbing vibration or impact transferred from a road surface to the vehicle body, a shock absorber for controlling an operation of the spring, a suspension arm device for controlling an operation of the wheel, and the like.

One side of the suspension arm device is connected to a wheel-side member and the other side thereof is connected to a vehicle-body-side member, thereby improving the straight driving property and steering stability of the vehicle. Typically, the suspension arm device may have a closed-box section to ensure the rigidity required for the suspension arm.

Such a closed-box section may be formed by welding a plurality of different constituent elements. This may result in a degradation in manufacturing efficiency and an increase in manufacturing costs.

### SUMMARY

The present disclosure was made to solve the above-mentioned matters, and the present disclosure is for the purpose of providing a suspension arm device in which a body portion is formed by an integral hollow pipe with a closed-box section, and which is capable of providing a rigidity required for the suspension arm device and reducing a weight and manufacturing cost of a product. Further, the present disclosure is for the purpose of providing a suspension arm device in which a fixing portion of a panel portion coupled to a body portion has a surface corresponding to an outer surface of the body portion, thereby making a manufacture of the suspension arm device easier.

According to an example embodiment of the present disclosure, a suspension arm device may include: a body portion; and a panel portion including a plurality of fixing portions fixed to the body portion. One surface of each of the plurality of fixing portions, which faces the body portion, may have a shape corresponding to an outer surface of the body portion.

In an aspect, the panel portion may include a first panel portion which includes a first fixing portion and is arranged below the body portion, and a second fixing portion which includes a second panel portion and is arranged above the body portion. The first panel portion and the second panel portion may face each other.

In an aspect, the first fixing portion and the second fixing portion may cover a portion of the outer surface of the body portion. The first fixing portion and the second fixing portion may be coupled to the body portion by welding.

In an aspect, the suspension arm device may further include a ball joint arranged at joint openings defined in the first panel portion and the second panel portion. The first panel portion and the second panel portion may be coupled to each other by the ball joint.

In an aspect, the suspension arm device may further include a plurality of bush pipes coupled to tips of the body portion and provided to be spaced apart from each other in a first direction. Bush openings respectively are defined in the plurality of bush pipes.

In an aspect, the suspension arm device may further include a plurality of bushes provided to be spaced apart from each other in the first direction. The plurality of bushes may be respectively arranged at the bush openings to be coupled to the bush pipes.

In an aspect, the panel portion may be manufactured by pressing.

In an aspect, the body portion may include a first body portion extending in a first direction, a second body portion extending in a second direction intersecting the first direction from a first side of both sides of the first body portion in the first direction, and a third body portion extending in the second direction from a second side of the both sides of the first body portion in the first direction.

In an aspect, a boundary between the first body portion and the second body portion and a boundary between the first body portion and the third body portion may have a curved shape in a plan view.

In an aspect, the curved shape may be formed by bending.

In an aspect, the body portion may have an internal space of a hollow closed cross-sectional structure at a center thereof.

According to another example embodiment of the present disclosure, a method of manufacturing a suspension arm device may include: providing a body portion, a panel portion including a plurality of fixing portions, and bush pipes; coupling the panel portion and the bush pipes to the body portion; coupling a ball joint to the panel portion; and coupling bushes to the bush pipes, respectively. The plurality of fixing portions may face the body portion, and one surface of each of the plurality of fixing portions, which faces the body portion, may have a shape corresponding to an outer surface of the body portion.

In an aspect, the providing of the body portion, the panel portion, and the bush pipes may include manufacturing the panel portion by pressing.

In an aspect, the coupling of the panel portion and the bush pipes to the body portion may include coupling the plurality of fixing portions to the body portion by welding, and coupling the bush pipes to the body portion by the welding.

In an aspect, the coupling of the ball joint to the panel portion may include coupling a case to a joint opening defined in the panel portion in a press-fitting manner.

According to an example embodiment of the present disclosure, a body portion is formed by an integral hollow pipe with a closed-box section, which eliminates a need to additionally perform welding to form the closed-box section. This makes it possible to provide rigidity required for a suspension arm device and reduce a weight and manufacturing cost of a product. Further, a panel portion coupled to the body portion includes a fixing portion, and a surface of the fixing portion, which faces the body portion, has a shape corresponding to an outer surface of the body portion. This makes it possible to easily perform coupling the body portion to the panel portion, which facilities the manufacture of the suspension arm device.

### BRIEF DESCRIPTION OF THE DRAWINGS

FIG. 1 is a perspective view of a suspension arm device according to an example embodiment of the present disclosure.

FIG. 2 is an exploded perspective view of the suspension arm device illustrated in FIG. 1.

FIG. 3 is a cross-sectional view taken along line I-I′ in FIG. 2.

FIGS. 4A and 4B are cross-sectional views taken along line II-II′ in FIG. 2.

FIG. 5 is a flowchart illustrating a method of manufacturing the suspension arm device illustrated in FIGS. 1 and 2.

### DETAILED DESCRIPTION

Advantages and features of the present disclosure, and a method of achieving them, will become more apparent by example embodiments described below in detail in conjunction with the accompanying drawings. However, the present disclosure is not limited to example embodiments which will be described later, and may be implemented in various different forms. The present example embodiments merely completely describe the present disclosure, and are provided to faithfully explain the scope of the present disclosure to those skill in the art to which the present disclosure pertains. The present disclosure is merely defined by the scope of the claims. Throughout the specification, like reference numerals refer to like constituent elements.

Throughout the present specification, when a constituent element is referred to as being arranged “above” or “on” another constituent element, the constituent element may be arranged “directly above” another constituent element, or may be arranged above another constituent element by intervening yet another constituent element therebetween. Further, the term “and/or” may be used to represent a combination of a plurality of related items described herein or at least one of the plurality of related items.

Spatially relative terms such as “below,” “beneath,” “lower,” “above,” “upper,” and the like may be used to easily explain a correlation between a constituent element and another constituent element as illustrated in the drawings. Such spatially relative terms should be understood as encompassing different directions of the constituent element in use or during operation, in addition to directions illustrated in the drawings. Throughout the present specification, the same reference numerals will be given to the same constituent elements.

Further, although the terms including ordinal numbers such as a first, a second and the like used herein may be used to describe various constituent elements and/or various sections, such constituent elements and/or various sections should not be limited by terms including the ordinal numbers. The above terms may be merely used to distinguish a constituent element or a section from another constituent element or another section. For example, a first constituent element or a first section used herein may be named as a second constituent element or a second section in another description of the specification without departing from the scope of the present disclosure.

Example embodiments of the present disclosure will be described with reference to schematic plan views and cross-sectional views illustrated in the present specification. Explanatory diagrams may be modified according to a manufacturing technique and/or an allowable error. The example embodiments of the present disclosure are not limited to specific forms illustrated herein, but may also encompass a case where a mode is changed according to a manufacturing process. Further, regions illustrated in the drawings have schematic attributes, and patterns of the regions illustrated in the drawings merely illustrate specific forms of the regions in a configuration, which are not intended to limit the scope of the present disclosure.

Hereinafter, preferred example embodiments of the present disclosure will be described in more detail with reference to the accompanying drawings.

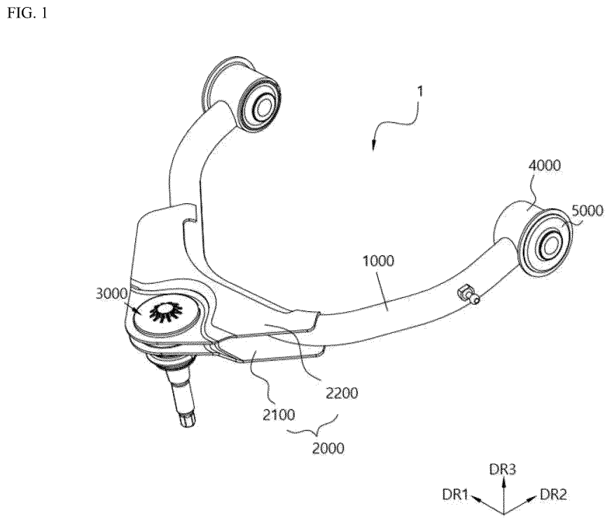

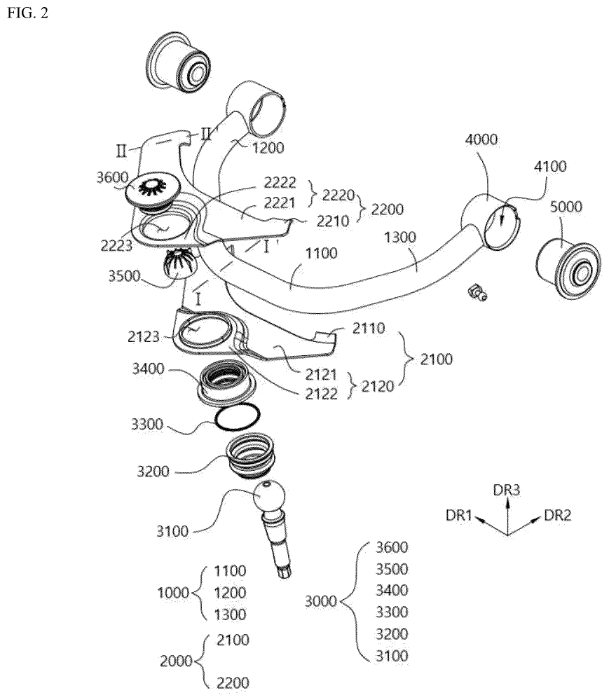

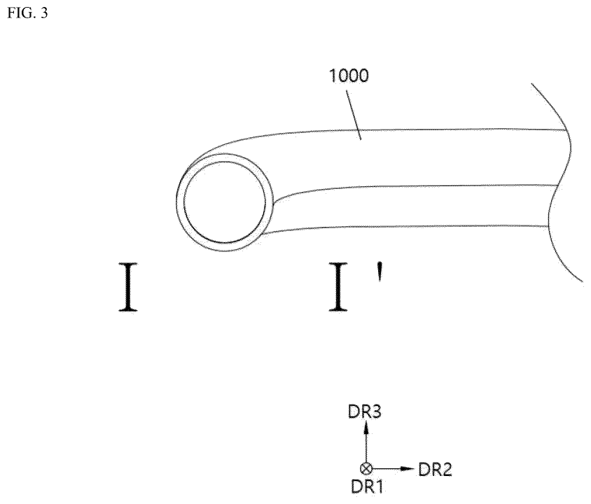

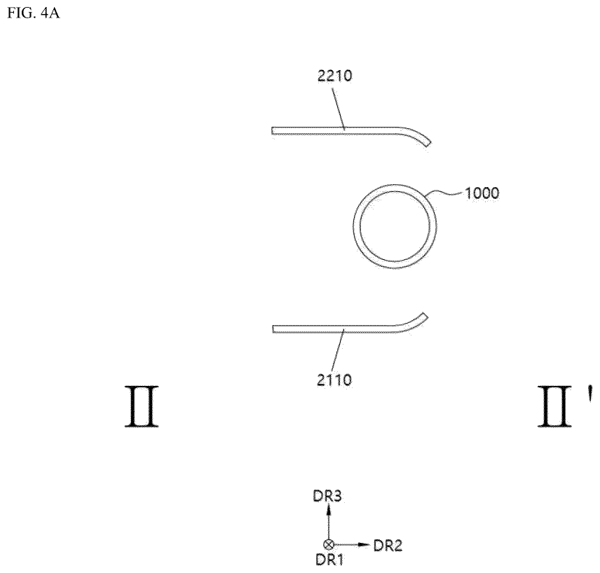

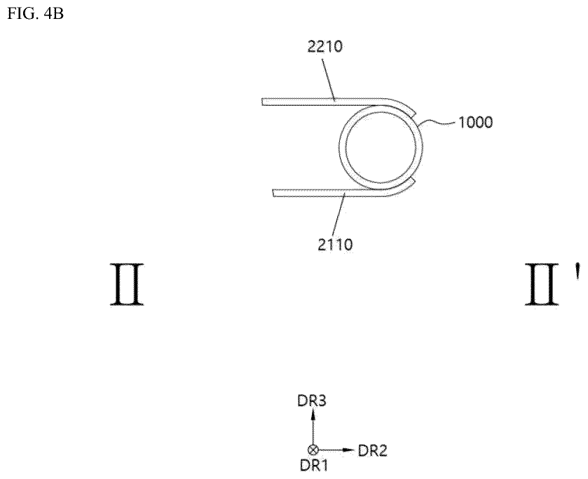

FIG. 1 is a perspective view of a suspension arm device according to an example embodiment of the present disclosure. FIG. 2 is an exploded perspective view of the suspension arm device illustrated in FIG. 1. FIG. 3 is a cross-sectional view taken along line I-I′ in FIG. 2. FIGS. 4A and 4B are cross-sectional views taken along line II-II′ in FIG. 2.

Referring to FIG. 1, a suspension arm device 1 may have a U-like shape, but is not limited thereto. The suspension arm device 1 may have various shapes.

The suspension arm device 1 may include a body portion 1000, a panel portion 2000, a ball joint 3000, a plurality of bush pipes 4000 spaced apart from one another in a first direction DR1, and a plurality of bushes 5000 spaced apart from one another in the first direction DR1.

The body portion 1000 may have a U-like shape. The body portion 1000 may have a pipe shape. As illustrated in FIG. 3, a cross-section of the body portion 1000 may be circular when viewed in a second direction DR2 intersecting the first direction DR1.

Referring to FIGS. 1 to 3, an interior of the body portion 1000 may be defined as a space. The interior of the body portion 1000 may have a hollow closed-box section structure. Since the interior of the body portion 1000 is defined as the space, a weight of the body portion 1000 may be lightened. Further, since the body portion 1000 has the hollow closed-box section structure, the rigidity of the body portion 1000 may be ensured.

As an example, the body portion 1000 may be manufactured by injecting iron or aluminum material into a mold in a molten state and solidifying the same. However, the material of the body portion 1000 is not limited thereto, but may be formed of other materials by other processing.

Hereinafter, a direction substantially perpendicular to a plane defined by the first direction DR1 and the second direction DR2 is defined as a third direction DR3. Further, the expression “in a plan view” used herein may be defined as viewed in the third direction DR3.

The body portion 1000 may include a first body portion 1100, a second body portion 1200, and a third body portion 1300. The first body portion 1100 may extend in the first direction DR1. The first body portion 1100 may be coupled to the panel portion 2000 described below.

The second body portion 1200 and the third body portion 1300 may extend in the second direction DR2 from both sides of the first body portion 1100 in the first direction DR1. The first body portion 1100, the second body portion 1200, and the third body portion 1300 may be formed substantially integrally with each other. The second body portion 1200 and the third body portion 1300 may be coupled to the plurality of bush pipes 4000 described below.

A boundary between the first body portion 1100 and the second body portion 1200, and a boundary between the first body portion 1100 and the third body portion 1300 may be curved in a plan view. The boundary between the first body portion 1100 and the second body portion 1200, and the boundary between the first body portion 1100 and the third body portion 1300 may be formed by bending. However, such a configuration is merely an example. The boundary between the first body portion 1100 and the second body portion 1200, and the boundary between the first body portion 1100 and the third body portion 1300 may be curved by another machining.

The bush pipes 4000 may be connected to tips of the body portion 1000, which are spaced apart from each other in the first direction DR1. The bush pipes 4000 may be connected to one of both sides of each of the second body portion 1200 and the third body portion 1300 in the second direction DR2. As an example, the bush pipes 4000 may be connected to the body portion 1000 by welding, but is not limited thereto. The bush pipes 4000 may be connected to the body portion 1000 in other manners. Each of the second body portion 1200 and the third body portion 1300 may have one side and the other side opposite the one side, which is adjacent to the first body portion 1100.

An outer surface of each of the bush pipes 4000 may have a circular shape in the first direction DR1. Bush openings 4100 may be formed in the centers of the bush pipes 4000, respectively. The bush openings 4100 may extend in the first direction DR1. A shape of each of the bush openings 4100 may be circular in the first direction DR1.

The bushes 5000 may be arranged in the bush openings 4100, respectively. The bushes 5000 may be coupled to the bush pipes 4000, respectively. The bushes 5000 may be coupled to the respective bush pipes 4000 in a press-fitting manner.

Referring to FIGS. 1, 2, 4A, and 4B, the panel portion 2000 may be coupled to the body portion 1000. The panel portion 2000 may be coupled to the first body portion 1100. The panel portion 2000 may be arranged between the second body portion 1200 and the third body portion 1300 in a plan view.

The panel portion 2000 may include a first panel portion 2100 and a second panel portion 2200. The first panel portion 2100 may be arranged below the body portion 1000. The second panel portion 2200 may be arranged above the body portion 1000. The first panel portion 2100 and the second panel portion 2200 may face each other in the third direction DR3.

The first panel portion 2100 may include a first fixing portion 2110 and a first flat portion 2120. The first flat portion 2120 may have an approximately triangular shape in a plan view.

The first flat portion 2120 may include a (1-1) th flat portion 2121 and a (1-2) th flat portion 2122. The (1-1) th flat portion 2121 and the (1-2) th flat portion 2122 may be arranged in the second direction DR2. The (1-2) th flat portion 2122 may extend from the (1-1) th flat portion 2121 in the second direction DR2. The (1-1) th flat portion 2121 may be arranged more adjacent to the body portion 1000 than the (1-2) th flat portion 2122. The (1-1) th flat portion 2121 and the (1-2) th flat portion 2122 may be formed substantially integrally with each other.

The (1-1) th flat portion 2121 and the (1-2) th flat portion 2122 may be arranged with a stepped portion therebetween. As an example, an upper surface of the (1-2) th flat portion 2122 may be higher in height than an upper surface of the (1-1) th flat portion 2121.

As an example, the stepped portion between the (1-1) th flat portion 2121 and the (1-2) th flat portion 2122 may be formed by pressing. However, the present disclosure is not limited thereto. The stepped portion between the (1-1) th flat portion 2121 and the (1-2) th flat portion 2122 may be formed by other manners.

A first joint opening 2123 may be defined by the (1-2) th flat portion 2122. The first joint opening 2123 may have a circular shape in a plane view.

The first fixing portion 2110 may extend from the (1-1) th flat portion 2121. As an example, a plurality of first fixing portions 2110 may be provided. One surface of each of the plurality of first fixing portions 2110 may have a shape corresponding to an outer surface of the body portion 1000. One surface of each of the plurality of first fixing portions 2110 may be defined as a surface facing the body portion 1000. As an example, as illustrated in FIG. 4A, one surface of each of the plurality of first fixing portions 2110 may be a downwardly-depressed surface. However, the present disclosure is not limited thereto. The shape of one surface of each of the plurality of first fixing portions 2110 may be changed to correspond to a shape of the outer surface of the body portion 1000.

As illustrated in FIG. 4B, one surface of each of the plurality of first fixing portions 2110 may cover a portion of the outer surface of the body portion 1000. The plurality of first fixing portions 2110 may be coupled to a portion of the outer surface of the body portion 1000 by welding.

Since one surface of each of the plurality of first fixing portions 2110 has a shape corresponding to the outer surface of the body portion 1000, the first panel portion 2100 may be easily coupled to the body portion 1000 as illustrated in FIG. 4B.

The second panel portion 2200 may be arranged above the first panel portion 2100. The second panel portion 2200 may be arranged to face the first panel portion 2100. The second panel portion 2200 may have a shape corresponding to the first panel portion 2100.

The second panel portion 2200 may include a second fixing portion 2210 and a second flat portion 2220. The second flat portion 2220 may have an approximately triangular shape in a plan view.

The second flat portion 2220 may include a (2-1) th flat portion 2221 and a (2-2) th flat portion 2222. The (2-1) th flat portion 2221 and the (2-2) th flat portion 2222 may be arranged in the second direction DR2. The (2-2) th flat portion 2222 may extend from the (2-1) th flat portion 2221 in the second direction DR2. The (2-1) th flat portion 2221 may be arranged more adjacent to the body portion 1000 than the (2-2) th flat portion 2222. The (2-1) th flat portion 2221 and the (2-2) th flat portion 2222 may be formed substantially integrally with each other.

The (2-1) th flat portion 2221 and the (2-2) th flat portion 2222 may be arranged with a stepped portion therebetween. As an example, an upper surface of the (2-2) th flat portion 2222 may be higher in height than an upper surface of the (2-1) th flat portion 2221.

As an example, the stepped portion between the (2-1) th flat portion 2221 and the (2-2) th flat portion 2222 may be formed by pressing. However, the present disclosure is not limited thereto. The stepped portion between the (2-1) th flat portion 2221 and the (2-2) th flat portion 2222 may be formed in other manners.

A second joint opening 2223 may be defined by the (2-2) th flat portion 2222. The second joint opening 2223 may have a circular shape in a plan view. The second joint opening 2223 may overlap the first joint opening 2123.

The second fixing portion 2210 may extend from the (2-1) th flat portion 2221. As an example, a plurality of second fixing portions 2210 may be provided. One surface of each of the plurality of second fixing portions 2210 may have a shape corresponding to the outer surface of the body portion 1000. One surface of each of the plurality of second fixing portions 2210 may be defined as a surface facing the body portion 1000. As an example, as illustrated in FIG. 4A, one surface of each of the plurality of second fixing portions 2210 may be an upwardly-depressed surface. However, the present disclosure is not limited thereto. The shape of one surface of each of the plurality of second fixing portions 2210 may be changed according to a shape of the outer surface of the body portion 1000.

As illustrated in FIG. 4B, one surface of each of the plurality of second fixing portions 2210 may cover a portion of the outer surface of the body portion 1000. The second fixing portions 2210 may be arranged above the first fixing portions 2110. The second fixing portions 2210 may be coupled to a portion of the outer surface of the body portion 1000 by welding.

Since one surface of each of the plurality of second fixing portions 2210 has a shape corresponding to the outer surface of the body portion 1000, the second panel portion 2200 may be easily coupled to the body portion 1000 as illustrated in FIG. 4B.

The ball joint 3000 may be arranged at the first joint opening 2123 and the second joint opening 2223. The ball joint 3000 may be coupled to the panel portion 2000. As an example, the ball joint 3000 may be coupled to the panel portion 2000 by welding. The first panel portion 2100 and the second panel portion 2200 may be coupled to each other by the ball joint 3000.

The ball joint 3000 may include a ball stud 3100, a dust cover 3200, a ring clip 3300, a case 3400, a bearing 3500, and a cover 3600. The ball stud 3100, the dust cover 3200, the ring clip 3300, the case 3400, the bearing 3500, and the cover 3600 may be sequentially coupled to each other in the third direction DR3.

A ball member may be provided at one side of the ball stud 3100. One side of the ball stud 3100 may be defined as a side facing the cover 3600.

The dust cover 3200 may be arranged below the first panel portion 2100. The ball stud 3100 may be inserted into an opening (not illustrated) defined in the center of the dust cover 3200. The ball stud 3100 may pass through the dust cover 3200. The dust cover 3200 may surround the ball stud 3100 to prevent external foreign matters from entering the ball stud 3100.

The ring clip 3300 may be coupled to the dust cover 3200. A radius of the ring clip 3300 may be greater than that of an upper surface of the dust cover 3200 in a plan view. The ring clip 3300 may fix the dust cover 3200 to the case 3400, which will be described below.

The case 3400 may be arranged above the dust cover 3200. The case 3400 may be coupled to the dust cover 3200. The ball stud 3100 may be inserted into an opening (not illustrated) defined in the center of the case 3400. The ball stud 3100 may pass through the casc 3400.

A radius of an outer surface of the case 3400 may be varied. As an example, as illustrated in FIG. 2, the radius of the outer surface of the case 3400 may be smaller toward the panel portion 2000. That is, a radius of a lower surface of the case 3400 may be larger than that of the upper surface of the case 3400.

The radius of the lower surface of the case 3400 may be greater than those of the first joint opening 2123 and the second joint opening 2223. The radius of the upper surface of the case 3400 may be smaller than those of the first joint opening 2123 and the second joint opening 2223. Thus, a portion of the case 3400 may be inserted into the first joint opening 2123 and the second joint opening 2223, and a remaining portion thereof may be arranged below the first panel portion 2100.

A portion of the ball stud 3100 passing through the dust cover 3200 and the case 3400 may be exposed outward from the case 3400 in a plan view.

The bearing 3500 may be coupled to the ball member exposed to the outside. The bearing 3500 may cover the ball member. Although not illustrated, a surface of the bearing 3500, which faces the ball member, may have a shape corresponding to an outer surface of the ball member.

The cover 3600 may be arranged above the bearing 3500. The cover 3600 may be coupled to the first joint opening 2123 and the second joint opening 2223.

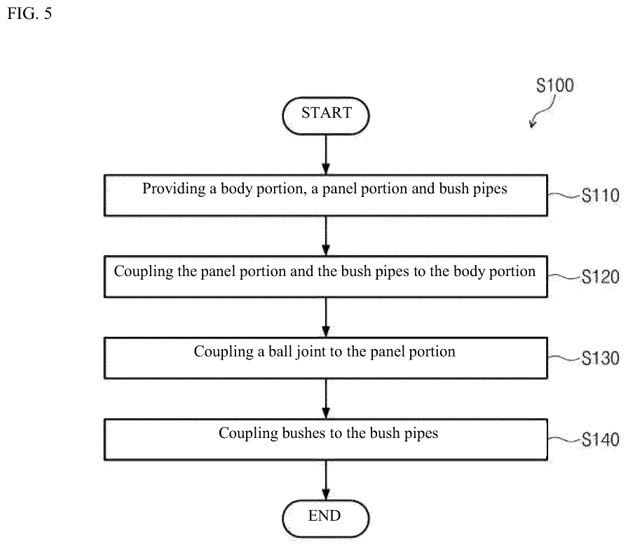

FIG. 5 is a flowchart illustrating a method of manufacturing the suspension arm device illustrated in FIGS. 1 and 2.

A body portion 1000, a panel portion 2000, bush pipes 4000, bushes 5000, and a ball joint 3000 described with reference to FIG. 5 are substantially identical to the body portion 1000, the panel portion 2000, the bush pipes 4000, the bushes 5000, and the ball joint 3000 illustrated in FIGS. 1 and 2, and thus descriptions there will be omitted or briefly made.

Referring to FIGS. 2 and 5, a method S100 of manufacturing the suspension arm device may include Operation S110 of providing the body portion 1000, the panel portion 2000, the bush pipes 4000, and the case 3400.

The body portion 1000 may be manufacturing by bending. The body portion 1000 may have a plurality of curved regions by the bending. The body portion 1000 may include a first body portion 1100, a second body portion 1200, and a third body portion 1300, which are distinguished from each other by the curved regions.

The method S100 of manufacturing the suspension arm device may include Operation S120 of coupling the panel portion 2000 and the bush pipes 4000 to the body portion 1000. The first panel portion 2100 of the panel portion 2000 may be arranged below the body portion 1000, and the second panel portion 2200 may be arranged above the body portion 1000. As an example, the first panel portion 2100 and the second panel portion 2200 may be manufactured by pressing.

As the first panel portion 2100 and the second panel portion 2200 move in the third direction DR3, the first fixing portion 2110 of the first panel portion 2100 and the second fixing portion 2210 of the second panel portion 2200 may be coupled to the outer surface of the body portion 1000. The first fixing portion 2110 and the second fixing portion 2210 may cover a portion of the outer surface of the body portion 1000. As illustrated in FIGS. 4A and 4B, one surface of each of the first fixing portion 2110 and the second fixing portion 2210, which faces the body portion 1000, may have a shape corresponding to the outer surface of the body portion 1000. Thus, the first panel portion 2100 and the second panel portion 2200 may casily be coupled to the body portion 1000.

Although not illustrated, after the first fixing portion 2110 and the second fixing portion 2210 cover the outer surface of the body portion 1000, the first fixing portion 2110 and the second fixing portion 2210 may be fixed to the outer surface of the body portion 1000 by welding. However, such a configuration is merely an example. The first fixing portion 2110 and the second fixing portion 2210 may be coupled to the body portion 1000 in various manners.

The bush pipes 4000 may be coupled to the tips of the body portion 1000, which are spaced apart from one another in the first direction DR1. As an example, the bush pipes 4000 may be coupled to the body portion 1000 by welding.

The method S100 of manufacturing the suspension arm device may include Operation S130 of coupling the ball joint 3000 to the panel portion 2000. Operation S130 of coupling the ball joint 3000 may include coupling the case 3400 to the panel portion 2000. The case 3400 may be coupled to the first panel portion 2100 and the second panel portion 2200. The case 3400 may be coupled into the first joint opening 2123 and the second joint opening 2223 respectively defined in the first panel portion 2100 and the second panel portion 2200 in a press-fitting manner.

Operation S130 of coupling the ball joint 3000 may include coupling the ball stud 3100, the dust cover 3200, the ring clip 3300, the bearing 3500, and the cover 3600 to each other. The ball stud 3100, the dust cover 3200, the ring clip 3300, the bearing 3500, and the cover 3600 may be sequentially coupled to each other in the third direction DR3 while being inserted into the first joint opening 2123 and the second joint opening 2223 respectively defined in the first panel portion 2100 and the second panel portion 2200.

The method S100 of manufacturing the suspension arm device may include Operation S140 of coupling the bushes 5000 to the bush pipes 4000. The bushes 5000 may be coupled to the bush pipes 4000, respectively. The bushes 5000 may be arranged at the bush openings 4100 illustrated in FIG. 2. As an example, the bushes 5000 may be fastened to the bush pipes 4000 in a press-fitting manner.

Although the present disclosure has been described with reference to the above example embodiments, it should be noted that various modification, and variations can be devised by those skilled in the art to which the present disclosure pertains without departing from the technical spirit and scope of the present disclosure. Further, the example embodiments described herein are merely examples for describing the technical sprit of the present disclosure, and the technical sprit of the present disclosure is not limited to the example embodiments. Further, the scope of the present disclosure should be construed within the appended claims, and all technical ideas falling within the equivalent scope thereof should be interpreted as being included in the scope of the disclosure.

### EXPLANATION OF REFERENCE NUMERALS

1: Suspension arm device
1000: Body portion
3000: Ball joint
4000: Bush pipe
5000: Bush
2000: Panel portion
2120: First flat portion
2110: First fixing portion
2220: Second flat portion
2210: Second fixing portion

What is claimed is:

1. A suspension arm device, comprising:
a body portion; and
a panel portion including a plurality of fixing portions fixed to the body portion,
wherein one surfaces of the plurality of fixing portions which face the body portion have a shape in which the one surfaces correspond to an outer surface of the body portion.

2. The suspension arm device of claim 1, wherein the panel portion includes a first panel portion which includes a first fixing portion and is arranged below the body portion; and
a second panel portion which includes a second fixing portion and is arranged above the body portion, and
wherein the first panel portion and the second panel portion face each other.

3. The suspension arm device of claim 2, wherein the first fixing portion and the second fixing portion cover a portion of the outer surface of the body portion, and wherein the first fixing portion and the second fixing portion are coupled to the body portion through welding.

4. The suspension arm device of claim 2, further comprising:
a ball joint arranged at joint openings defined in the first panel portion and the second panel portion,
wherein the first panel portion and the second panel portion are coupled to each other by the ball joint.

5. The suspension arm device of claim 1, further comprising:
a plurality of bush pipes coupled to tips of the body portion and provided to be spaced apart from each other in a first direction,
wherein bush openings respectively are defined in the plurality of bush pipes.

6. The suspension arm device of claim 5, further comprising:
a plurality of bushes provided to be spaced apart from each other in the first direction,
wherein the plurality of bushes are respectively arranged at the bush openings to be coupled to the bush pipes.

7. The suspension arm device of claim 1, wherein the panel portion is manufactured through pressing.

8. The suspension arm device of claim 1, wherein the body portion includes:
a first body portion extending in a first direction;
a second body portion extending in a second direction intersecting the first direction from a first side of both sides of the first body portion in the first direction; and
a third body portion extending in the second direction from a second side of the both sides of the first body portion in the first direction.

9. The suspension arm device of claim 8, wherein a boundary between the first body portion and the second body portion and a boundary between the first body portion and the third body portion have a curved shape in a plan view.

10. The suspension arm device of claim 9, wherein the curved shape is formed through bending.

11. The suspension arm device of claim 1, wherein the body portion has an internal space of a hollow closed cross-sectional structure at a center thereof.

12. A method of manufacturing a suspension arm device, the method comprising:
providing a body portion, a panel portion including a plurality of fixing portions, and bush pipes;
coupling the panel portion and the bush pipes to the body portion;
coupling a ball joint to the panel portion; and
coupling bushes to the bush pipes, respectively,
wherein the plurality of fixing portions faces the body portion, and
wherein one surfaces of the plurality of fixing portions which face the body portion have a shape in which the one surfaces correspond to an outer surface of the body portion.

13. The method of claim 12, wherein the providing of the body portion, the panel portion, and the bush pipes includes: manufacturing the panel portion through pressing.

14. The method of claim 12, wherein the coupling of the panel portion and the bush pipes to the body portion includes:
coupling the plurality of fixing portions to the body portion through welding; and
coupling the bush pipes to the body portion through welding.

15. The method of claim 12, wherein the coupling of the ball joint to the panel portion includes:
coupling a case to a joint opening defined in the panel portion in a press-fitting manner.
